(19) United States
(12) Patent Application Publication
(10) Pub. No.: US 2015/0058534 A1
(43) Pub. Date: Feb. 26, 2015

(54) MANAGING METHOD FOR CACHE MEMORY OF SOLID STATE DRIVE

(71) Applicant: LITE-ON IT CORPORATION, Taipei (TW)

(72) Inventor: Sin-Yu Lin, Hsinchu (TW)

(73) Assignee: LITE-ON IT CORPORATION, Taipei (TW)

(21) Appl. No.: 14/142,107

(22) Filed: Dec. 27, 2013

(30) Foreign Application Priority Data
Aug. 21, 2013 (CN) 201310365417.3

(51) Int. Cl. G06F 3/06

(52) U.S. Cl. CPC G06F 3/0656; G06F 3/0679; G06F 3/0619
USPC 711/103

(57) ABSTRACT

A managing method for a cache memory of a solid state drive includes the following steps. When the solid state drive decides to perform a garbage collection, a storing space of the cache memory is divided into plural storing portions. A first storing portion of the cache memory is set as a buffering unit for a garbage collection purpose. A second storing portion of the cache memory is set as a buffering unit for a writing purpose.

This application claims the benefit of People's Republic of China Application Serial No. 201310365417.3, filed Aug. 21, 2013, the subject matter of which is incorporated herein by reference.

### FIELD OF THE INVENTION

The present invention relates to a controlling method for a solid state drive, and more particularly to a managing method for a cache memory of a solid state drive.

### BACKGROUND OF THE INVENTION

FIG. 1 is a schematic functional block diagram illustrating a conventional storage device. As shown in FIG. 1, the storage device 10 is in communication with a host 12 in order to receive a read command or a write command from the host 12. For example, the host 12 is a computer host, and the storage device 10 is a hard disc drive or an optical disc drive.

The storage device 10 includes a controlling unit 101, a cache memory 103, and a storage element 105. The controlling unit 101 is in communication with the host 12 through an external bus 20. Consequently, commands and data can be exchanged between the controlling unit 101 and the host 12. According to a command from the host 12, the controlling unit 101 may access the data of the storage element 105. Moreover, the cache memory 103 is connected with the controlling unit 101 in order to temporarily store the write data from the host 12 or the read data requested by the host 12.

Generally, the external bus 20 may be a USB bus, an IEEE 1394 bus, an SATA bus, or the like. The storage element 105 is an optical disc or a magnetic disc.

As is well known, the cache memory 103 is used for temporarily storing the write data from the host 12 or the read data requested by the host 12. For example, in case that the host 12 issues the write command and the corresponding write data to the storage device 10, the write command and the corresponding write data are temporarily stored into the cache memory 103 by the controlling unit 101, and then the write data is processed (e.g. generation of ECC code) and stored into the storage element 105 by the controlling unit 101. Whereas, in case that the host 12 issues the read command to the storage device 10, the read data from the storage element 105 is temporarily stored into the cache memory 103 by the controlling unit 101, and then the read data is transmitted to the host 12 by the controlling unit 101.

From the above discussions, the cache memory 103 is used for temporarily storing the write data (i.e. for a writing purpose) when the host 12 issues the write command; and the cache memory 103 is used for temporarily storing the read data (i.e. for a reading purpose) when the host 12 issues the read command.

Recently, a novel storage device such as a solid state drive (SSD) is introduced into the market and becomes more popular. The solid state drive has the tendency to gradually replace the hard disc drive or the optical disc drive.

Generally, the solid state drive is a storage device that uses a NAND-based flash memory as a storage element. The NAND-based flash memory is a non-volatile memory. In other words, after a data is written to the flash memory, the data is still retained in the solid state drive if the system power is turned off.

Since the storage element of the solid state drive is distinguished, the cache memory of the solid state drive should have a specially-designed managing mechanism in order to enhance the operating efficiency of the solid state drive.

### SUMMARY OF THE INVENTION

A first embodiment of the present invention provides a managing method for a cache memory of a solid state drive. The managing method includes the following steps. When the solid state drive decides to perform a garbage collection, a storing space of the cache memory is divided into plural storing portions. A first storing portion of the cache memory is set as a buffering unit for a garbage collection purpose. A second storing portion of the cache memory is set as a buffering unit for a writing purpose.

A second embodiment of the present invention provides a managing method for a cache memory of a solid state drive. The managing method includes the following steps. In a step (a), the cache memory is designed for a writing purpose and/or a reading purpose according to an access command before the solid state drive performs a garbage collection. In a step (b), a first storing portion of the cache memory is set as a buffering unit for a garbage collection purpose and a second storing portion of the cache memory is set as a buffering unit for the writing purpose when the solid state drive decides to perform the garbage collection. In a step (c), the step (a) is repeatedly performed after the garbage collection is completed by the solid state drive.

A third embodiment of the present invention provides a solid state drive in communication with a host. The solid state drive includes a controlling unit, a flash memory, and a cache memory. The controlling unit is in communication with the host. The controlling unit receives an access command from the host. The flash memory is connected to the controlling unit. The cache memory is connected to the controlling unit. When the controlling unit decides to perform a garbage collection, a first storing portion of the cache memory is set as a buffering unit for a garbage collection purpose, and a second storing portion of the cache memory is set as a buffering unit for a writing purpose.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) is a schematic functional block diagram illustrating a conventional storage device;

FIG. 2 is a schematic functional block diagram illustrating a solid state drive according to an embodiment of the present invention;

FIG. 3 schematically illustrates a process of performing a garbage collection;

FIG. 4 schematically illustrates the variation of the writing speed of writing data into the solid state drive according to a write command while performing the garbage collection;

FIG. 5A is a flowchart illustrating a managing method for a cache memory of a solid state drive according to an embodiment of the present invention;

FIG. 5B schematically illustrates the variation of the writing speed of writing data into the solid state drive according to a write command while performing the garbage collection according to an embodiment of the present invention; and

FIG. 6 is a flowchart illustrating a managing method for a cache memory of a solid state drive according to another embodiment of the present invention.

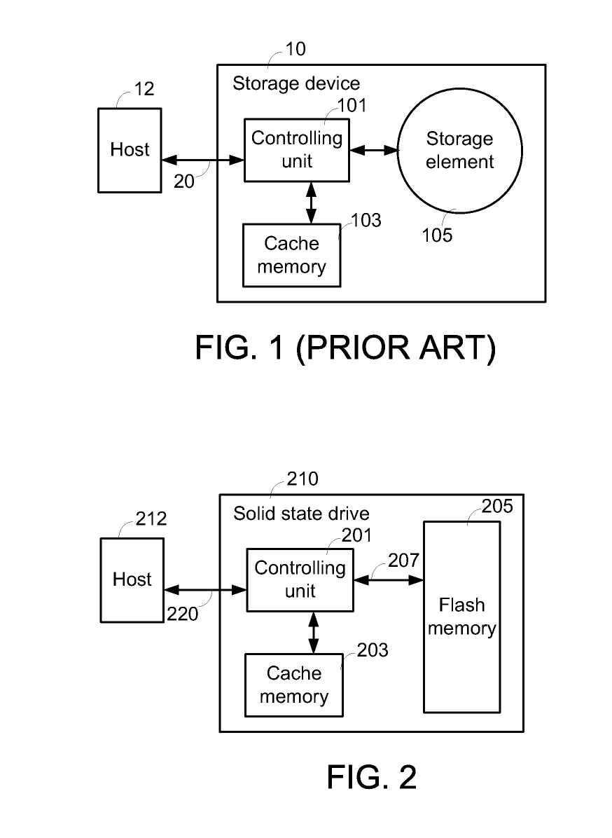

### DETAILED DESCRIPTION OF PREFERRED EMBODIMENTS

FIG. 2 is a schematic functional block diagram illustrating a solid state drive according to an embodiment of the present invention. As shown in FIG. 2, the solid state drive 210 includes a controlling unit 201, a cache memory 203, and a flash memory 205. The flash memory 205 is accessible by the controlling unit 201 through an internal bus 207. The controlling unit 201 is in communication with the host 212 through an external bus 220. Consequently, commands and data can be exchanged between the controlling unit 201 and the host 212. Moreover, the cache memory 203 is connected with the controlling unit 201 in order to temporarily store the write data from the host 220 or the read data requested by the host 212. Generally, the external bus 220 may be a USB bus, an IEEE 1394 bus, an SATA bus, or the like.

Since the material of the solid state drive 210 is different from the material of the storage element of the hard disc drive or the optical disc drive, the method of storing data is distinguished.

Generally, the flash memory 205 of the solid state drive 210 includes plural blocks. Each block includes plural pages (or sectors), for example 64 pages. Each page is typically 4K bytes in size. Due to the inherent properties of the flash memory 205, at least one page is written at a time during the writing operation, but a block is erased during the erasing operation.

In the flash memory 205, the block without any stored data is referred as a free block, and the block with the stored data is referred as a used block. In case that the data of a used block are all invalid data, the used block may be erased as a free block. Consequently, the free block can be used to store data again.

However, after the flash memory 205 has been accessed for a long time, each block of the flash memory 205 may contain some valid data and some invalid data. As long as the used block contains the valid data, the used block fails to be erased as the free block. Since the space of the flash memory 205 is occupied by a great number of invalid data, the writable space of the flash memory 205 is gradually reduced.

As the number of used blocks in the flash memory 205 gradually increases and the number of free blocks in the flash memory 205 gradually decreases, it is necessary to perform a garbage collection. Generally, when the number of free blocks in the flash memory 205 decreases to a threshold number, the garbage collection is started by the controlling unit 201. After the garbage collection is performed, the storing space of the invalid data in the used blocks can be released. Consequently, the write data inputted by the host 212 can be continuously stored into the flash memory 205.

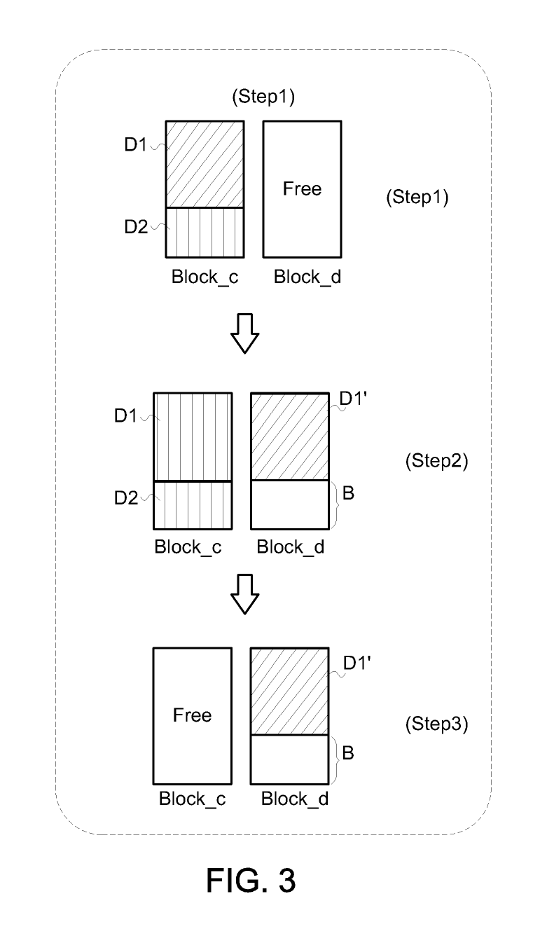

FIG. 3 schematically illustrates a process of performing a garbage collection. As shown in FIG. 3, the data D1 of the used block c (Block_c) are valid data, the data D2 of the used block c (Block_c) are invalid data, and the block d (Block_d) is a free block (Step 1). After the controlling unit 201 searches all blocks of the flash memory 205, the controlling unit 201 may decide to start the garbage collection on the used block c (Block_c). While the garbage collection is performed on the used block c (Block_c) by the controlling unit 201 (Step 2), the valid data D1 of the used block c (Block_c) are firstly moved to the free block d (Block_d) and refreshed as the valid data D1′. After the valid data D1′ is written into the free block d (Block_d), the free block d (Block_d) becomes another used block d (Block_d). Then, all data in the used block c (Block_c) are set as invalid data. Afterwards, in the step 3, the used block c (Block_c) is erased as a new free block c (Block_c). Meanwhile, one garbage collection is completed.

In other words, after the garbage collection is performed, the block c (Block_c) becomes a new free block. Moreover, the used block d (Block_d) still has other free space B for storing data. That is, after the garbage collection is performed, the free space B is a released space for allowing the host 212 to continuously store data. The size of the free space B is smaller than the size of one free block.

In the step 2 of the above process of performing the garbage collection, the valid data D1 of the used block c (Block_c) is written to the free block d (Block_d) and refreshed as the valid data D1′. In this step, the valid data D1 of the used block c (Block_c) is temporarily stored into the cache memory 203 by the controlling unit 201, then the valid data D1 is read from the cache memory 203 by the controlling unit 201, and finally the valid data D1 is written to the free block d (Block_d) and refreshed as the valid data D1′.

From the above discussions, the cache memory 203 of the solid state drive 210 is used for temporarily storing the write data (i.e. for a writing purpose), temporarily storing the read data (i.e. for a reading purpose), or temporarily storing the moved data from the flash memory 205 (i.e. for a garbage collection purpose).

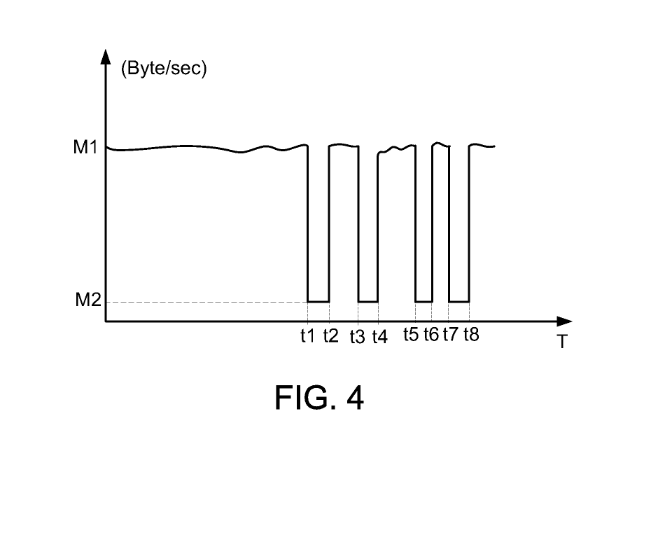

FIG. 4 schematically illustrates the variation of the writing speed of writing data into the solid state drive according to a write command while performing the garbage collection. When a write command is executed by the solid state drive 210, the cache memory 203 is used for temporarily storing the write data (i.e. for a writing purpose). Under this circumstance, the writing speed is maintained at the highest speed M1. The highest speed M1 is determined according to the capacity of the cache memory 203 and the operating speed of the controlling unit 201.

However, at the time point t1, the number of free blocks in the flash memory 205 decreases to a threshold number, and thus the garbage collection is started by the controlling unit 201. Moreover, at the time point t1, the controlling unit 201 may stop executing the write command from the host 212 temporarily. In other words, the write data input by the host 212 cannot be continuously stored into the flash memory 205.

From the time point t1 to the time point t2, the garbage collection is being performed by the controlling unit 201. Under this circumstance, the cache memory 203 is used for temporarily storing the moved data from the flash memory 205 (i.e. for a garbage collection purpose). Consequently, the writing speed of the solid state drive 210 drops down to M2 (e.g. 0 Byte/sec).

At the time point t2, the garbage collection is completed, and thus a storing space is released. Consequently, the write command is continuously executed by the controlling unit 201. From the time point t2 to the time point t3, the cache memory 203 is used for temporarily storing the write data (i.e. for a writing purpose). Consequently, the writing speed of the solid state drive 210 rises to the highest speed M1 again.

Similarly, from the time point t3 to the time point t4, from the time point t5 to the time point t6 and from the time point t7 to the time point t8, the garbage collection is being performed by the controlling unit 201. Under these circumstances, the writing speed of the solid state drive 210 drops down to M2 (e.g. 0 Byte/sec) again. Similarly, when the write command is continuously executed by the controlling unit 201, the writing speed of the solid state drive 210 rises to the highest speed M1 again.

From the above discussions, if the controlling unit 201 of the solid state drive 210 executes the write command while performing the garbage collection, the writing speed is intermittent. Under this circumstance, the user feels that it takes a long time for the solid state drive 210 to execute the write command. In other words, the performance of the solid state drive 210 in a unit time abruptly decreases.

Similarly, if the controlling unit 201 of the solid state drive 210 executes the read command while performing the garbage collection, the reading speed is also intermittent. In other words, the performance of the solid state drive 210 in unit time abruptly decreases.

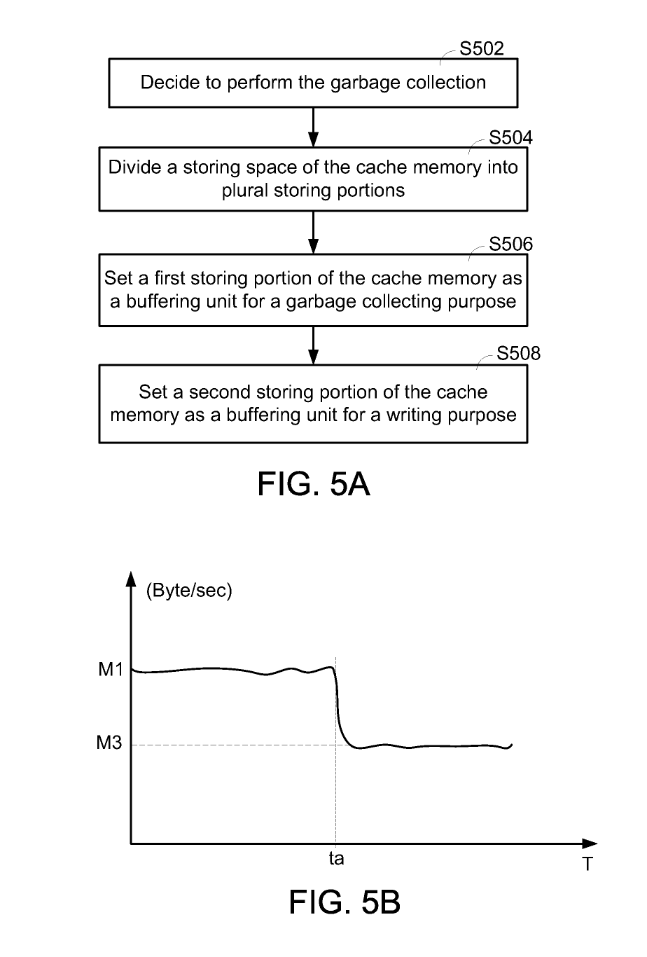

FIG. 5A is a flowchart illustrating a managing method for a cache memory of a solid state drive according to an embodiment of the present invention. FIG. 5B schematically illustrates the variation of the writing speed of writing data into the solid state drive according to a write command while performing the garbage collection according to an embodiment of the present invention. By using the managing method of the present invention, the performance of the solid state drive 210 can be more stable.

Please refer to FIG. 5A. When the controlling unit 201 of the solid state drive 210 decides to perform a garbage collection (Step S502), a storing space of the cache memory 203 is divided into plural storing portions (Step S504). Then, a first storing portion of the cache memory 203 is set as a buffering unit for a garbage collection purpose (Step S506), and a second storing portion of the cache memory 203 is set as a buffering unit for a writing purpose (Step S508).

The above method can effectively manage the cache memory 203. When the controlling unit 201 of the solid state drive 210 performs the garbage collection, the first storing portion of the cache memory 203 is used for temporarily storing the moved data from the flash memory 205. When the write command from the host 212 is received by the controlling unit 201 of the solid state drive 210, the second storing portion of the cache memory 203 is used for temporarily storing the write data. Consequently, while the controlling unit 201 of the solid state drive 210 performs the garbage collection, the controlling unit 201 may temporarily store the write data into the second storing portion of the cache memory 203 and execute the write command.

Please refer to FIG. 5B. While the controlling unit 201 of the solid state drive 210 executes the write command, the cache memory 203 is used for temporarily storing the write data (i.e. for a writing purpose). Under this circumstance, the writing speed is substantially maintained at the highest speed M1.

At the time point ta, the number of free blocks in the flash memory 205 decreases to a threshold number, and thus the garbage collection is started by the controlling unit 201. Since the second storing portion of the cache memory 203 is set as the buffering unit for the writing purpose, the controlling unit 201 can still executes the write command. Under this circumstance, the writing speed decreases to M3.

According to the managing method of the present invention, the controlling unit 201 of the solid state drive 210 can still execute the write command from the host 212 during the process of performing the garbage collection. Consequently, the performance of the solid state drive 210 is still satisfied.

Alternatively, in the solid state drive 210, a third storing portion of the cache memory 203 may be set as a buffering unit for temporarily storing the read data (i.e. for a reading purpose). In other words, the controlling unit 201 of the solid state drive 210 can still execute the read command and the write command from the host 212 during the process of performing the garbage collection. Consequently, the performance of the solid state drive 210 is still satisfied.

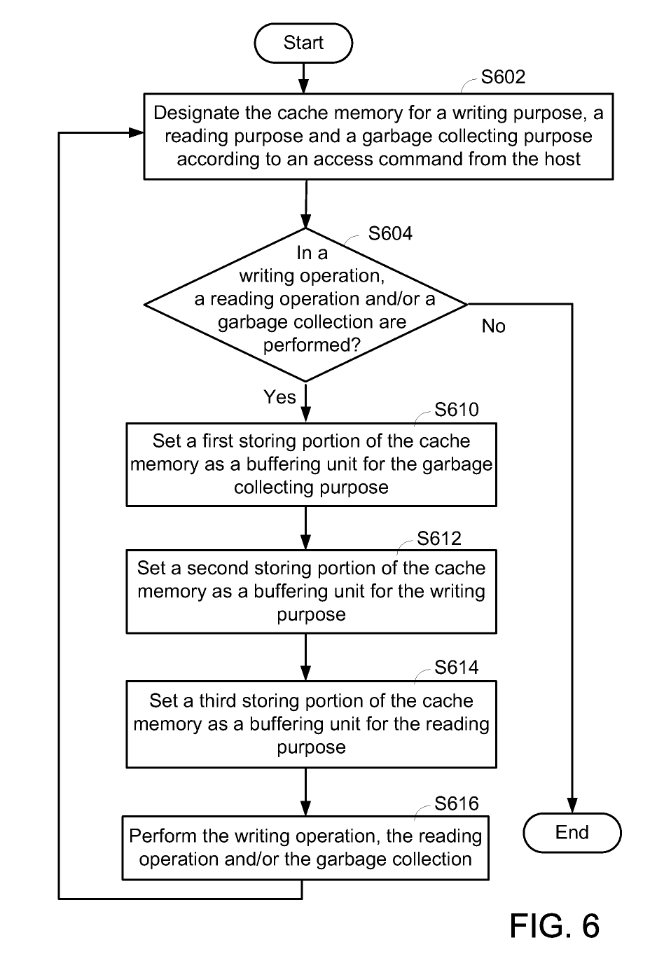

FIG. 6 is a flowchart illustrating a managing method for a cache memory of a solid state drive according to another embodiment of the present invention. Firstly, according to an access command from the host 212, the cache memory 203 is designated for a writing purpose, a reading purpose and a garbage collection purpose (Step 602).

Determining if the controlling unit 201 of the solid state drive 210 starts to perform a writing operation, a reading operation and/or a garbage collection (Step S604), a first storing portion of the cache memory 203 is set as a buffering unit for the garbage collection purpose (Step S610), a second storing portion of the cache memory 203 is set as a buffering unit for the writing purpose (Step S612), and a third storing portion of the cache memory 203 is set as a buffering unit for the reading purpose (Step S614). Then, the writing operation, the reading operation and/or the garbage collection are performed (Step S616).

Then, the step S602 and the step S604 are repeatedly performed until the condition of the step S604 is not satisfied. Meanwhile, the flowchart of the managing method is ended.

From the above descriptions, the present invention provides a managing method for a cache memory of a solid state drive. According to the managing method of the present invention, the controlling unit 201 of the solid state drive 210 can still execute the access command from the host 212 during the process of performing the garbage collection. Consequently, the performance of the solid state drive 210 is still satisfied.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A managing method for a cache memory of a solid state drive, the managing method comprising steps of:
dividing a storing space of the cache memory into plural storing portions when the solid state drive decides to perform a garbage collection;
setting a first storing portion of the cache memory as a buffering unit for a garbage collection purpose; and
setting a second storing portion of the cache memory as a buffering unit for a writing purpose.

2. The managing method as claimed in claim 1, wherein when a write command is received by the solid state drive, the solid state drive temporarily stores a write data into the second storing portion of the cache memory and executes the write command.

3. The managing method as claimed in claim 1, wherein a moved data from a flash memory of the solid state drive is temporarily stored in the first storing portion of the cache memory.

4. The managing method as claimed in claim 1, further comprising a step of setting a third storing portion of the cache memory as a buffering unit for a reading purpose, wherein when a read command is received by the solid state drive, the solid state drive temporarily stores a read data into the third storing portion of the cache memory and executes the read command.

5. A managing method for a cache memory of a solid state drive, the managing method comprising steps of:
(a) designing the cache memory for a writing purpose and/or a reading purpose according to an access command before the solid state drive performs a garbage collection;
(b) setting a first storing portion of the cache memory as a buffering unit for a garbage collection purpose and setting a second storing portion of the cache memory as a buffering unit for the writing purpose when the solid state drive decides to perform the garbage collection; and
(c) repeatedly performing the step (a) after the garbage collection is completed by the solid state drive.

6. The managing method as claimed in claim 5, wherein the access command is a write command, wherein when the write command is received by the solid state drive, the solid state drive temporarily stores a write data into the second storing portion of the cache memory and executes the write command.

7. The managing method as claimed in claim 5, wherein a moved data from a flash memory of the solid state drive is temporarily stored in the first storing portion of the cache memory.

8. The managing method as claimed in claim 5, wherein the step (b) further comprises a step of setting a third storing portion of the cache memory as a buffering unit for a reading purpose when the access command is a read command, wherein when the read command is received by the solid state drive, the solid state drive temporarily stores a read data into the third storing portion of the cache memory and executes the read command.

9. A solid state drive in communication with a host, the solid state drive comprising:
a controlling unit in communication with the host, wherein the controlling unit receiving an access command from the host;
a flash memory connected to the controlling unit; and
a cache memory connected to the controlling unit,
wherein when the controlling unit decides to perform a garbage collection, a first storing portion of the cache memory is set as a buffering unit for a garbage collection purpose, and a second storing portion of the cache memory is set as a buffering unit for a writing purpose.

10. The solid state drive as claimed in claim 9, wherein if the access command is a write command, the controlling unit temporarily stores a write data into the second storing portion of the cache memory and executes the write command.

11. The solid state drive as claimed in claim 9, wherein a moved data from the flash memory of the solid state drive is temporarily stored in the first storing portion of the cache memory.

12. The solid state drive as claimed in claim 9, wherein a third storing portion of the cache memory is further set as a buffering unit for a reading purpose when the access command is a read command, the solid state drive temporarily stores a read data into the third storing portion of the cache memory and executes the read command.

13. The solid state drive as claimed in claim 12, wherein before the garbage collection is performed by the controlling unit, the cache memory is designated for the writing purpose or the reading purpose according to the access command.
